(19) United States
(12) Patent Application Publication
(10) Pub. No.: US 2022/0075040 A1
(43) Pub. Date: Mar. 10, 2022

(54) ONLINE CALIBRATION OF LIDAR DEVICES

(71) Applicant: Robert Bosch GmbH, Stuttgart (DE)

(72) Inventors: Annette Frederiksen, Renningen (DE); Jan Preinfalk, Stuttgart (DE)

(21) Appl. No.: 17/445,906

(22) Filed: Aug. 25, 2021

(30) Foreign Application Priority Data
Sep. 10, 2020 (DE) 102020211369.6

(51) Int. Cl. G01S 7/497

(52) U.S. Cl. CPC G01S 7/497; G01S 2007/4977

(57) ABSTRACT

A method for calibrating a LIDAR device. Beams are generated and emitted by a beam source. Beams reflected and/or backscattered by objects in a scanning range of the LIDAR device and beams reflected and/or backscattered by a reflection structure applied on a glass cover of the LIDAR device are received by a detector. A reflection pattern is ascertained based on the beams reflected and/or backscattered by the reflection structure applied on the glass cover and is compared to a reference pattern. At least one corrective measure is taken to calibrate the LIDAR device in the event of a deviation between the ascertained reflection pattern and the reference pattern. A method for ascertaining a fogged glass cover and a LIDAR device are also provided.

### CROSS REFERENCE

The present application claims the benefit under 35 U.S.C. § 119 of German Patent Application No. DE 102020211369.6 filed on Sep. 10, 2020, which is expressly incorporated herein by reference in its entirety.

### FIELD

The present invention relates to a method for calibrating a LIDAR device. The present invention further relates to a method for ascertaining a fogged glass cover of a LIDAR device as well as to a LIDAR device.

### BACKGROUND INFORMATION

LIDAR devices are an important component of automated vehicles and allow for the technical implementation of various driving functions. Following the production of the LIDAR device, the latter is calibrated in the factory in order to ensure the requirements regarding the angle of measurement and the scanning range. Moreover, a LIDAR device used in a vehicle must remain operative in various weather conditions and temperatures. In particular at low temperatures, additional heating structures are used in the glass cover or protective glass of the LIDAR device in order to prevent the glass cover from fogging due to atmospheric humidity or ice buildup.

The mechanical, optical and electrical properties of individual components of the LIDAR device may change during the operation due to environmental influences such as temperature, but also due to aging of a component. It is therefore possible that a static calibration, in particular an angular measurement and a distance measurement, is no longer valid. The detection of these changes and the adaptation of the calibration values may be implemented by a continuous analysis of the point cloud of the LIDAR device with the aid of so-called perception algorithms. Furthermore, a monitoring of reference points in the housing in the dark phase or outside of the regular operation of the LIDAR device is conventional.

### SUMMARY

An object of the present invention is to provide a cost-efficient and technically simple method for the online calibration of a LIDAR device.

This objective may be achieved by example embodiments of the present invention. Advantageous developments of the present invention disclosed herein.

According to one aspect of the present invention, a method is provided for calibrating a LIDAR device. For this purpose, in a step, beams are generated and emitted by a beam source.

Beams reflected and/or backscattered by objects in a scanning range of the LIDAR device and beams reflected and/or backscattered by a reflection structure applied on a glass cover of the LIDAR device are received by a detector.

In accordance with an example embodiment of the present invention, depending on an illumination of the scanning range, a reflection structure situated on the glass cover may likewise be illuminated and respective backscattered beams may be detected by the detector. The detector is thus able to receive beams reflected on the reflection structure and beams reflected in the scanning range outside of the LIDAR device.

In accordance with an example embodiment of the present invention, in a further step, a reflection pattern based on the beams reflected and/or backscattered by the reflection structure applied on the glass cover is ascertained and compared to a reference pattern.

In the subsequent evaluation of the received beams, it is possible to extract the reflection pattern, which is generated by the reflection structure. The reflection pattern preferably may correspond to a geometric distribution and arrangement of the reflection structure.

In the event of a deviation between the ascertained reflection pattern and the reference pattern, at least one corrective measure is taken for calibrating the LIDAR device.

The reference pattern may be ascertained during the production of the LIDAR device or during the initial operation of the LIDAR device and may be stored in a control unit. This initially ascertained reference pattern may be subsequently used as a comparison pattern for the ascertained reference patterns in order to determine deviations from the initial boundary conditions or from factory calibration values.

The method allows for a long-term reliable functioning of the LIDAR device based on an online calibration. Such an online calibration may be performed continuously or at defined time intervals in the operation of the LIDAR device.

The reflection structure may for example take the form of heating structures having a defined position and reflectivity in the glass cover or protective glass of the LIDAR device.

Depending on the form and orientation of the reflection structure, the method makes it possible to detect shifts and distortions of the visual range in the horizontal direction and/or in the vertical direction during the regular operation of the LIDAR device.

The method is based on the basic idea that the reflection structure in the glass cover has a reflectivity that differs from reflectivities of objects outside of the LIDAR device.

Electrically conductive materials, engravings and/or electrically insulating materials may be used as materials for implementing the reflection structure. As electrically conductive materials, it is possible to use for example transparent materials such as indium tin oxide, thin metal layers or opaque materials such as metal wires. The position of the reflection structure may be determined exactly horizontally and vertically on the basis of the position of the reflection or echo or the change of the local background light. The reflection or the beams reflected on the reflection structure remain within the LIDAR device, so that an influence of external factors on the measurement is negligible.

In the case of a pixelated detector, such as a CMOS or CCD detector for example, it is additionally possible to determine the position and distribution of the intensity distribution generated by the reflection structure by an analysis of the detector image.

The positions of the reflection structure in the glass cover may be determined during operation and a deviation may be detected with respect to the values ascertained during the production. When a deviation is detected, the visual range may be corrected accordingly.

In accordance with an example embodiment of the present invention, as a possible corrective measure for calibrating the LIDAR device, it is possible for example to perform corrections in the evaluation of the measurement data of the detector and/or corrections in the deflection of the generated beams. It is possible, for example, to reduce or enlarge a deflection angle of a deflection mirror by an adapted electronic control. Alternatively or additionally, a software-based correction of deviations with respect to factory parameters may be performed in the evaluation of the received beams.

The method may be implemented without additional installation space and with minimal additional costs. In particular, there are various possibilities for arranging and structuring or designing the reflection structure. An extensive online calibration of the angular position in the visual range or scanning range of the LIDAR device is possible.

The online calibration of the LIDAR device may be performed in parallel to the regular operation so that it is not necessary additionally to switch on the LIDAR device in the dark phase or in stand-by mode.

In another specific embodiment of the present invention, the reflection pattern is ascertained from beams reflected and/or backscattered by a reflection structure in the form of a heating structure. This makes it possible to use the heating structures already built into the glass cover of the LIDAR device additionally for the online calibration. Apart from preventing the glass cover from fogging up or freezing over, the heating structures are able to fulfill an additional function.

According to another aspect of the present invention, a method is provided for ascertaining a fogged glass cover of a LIDAR device. For this purpose, beams are generated and emitted by a beam source of the LIDAR device.

In accordance with an example embodiment of the present invention, beams reflected and/or backscattered by objects in a scanning range of the LIDAR device and beams reflected and/or backscattered by a reflection structure applied on a glass cover of the LIDAR device are received by a detector.

Subsequently, a reflectivity distribution of the reflection structure is ascertained at the detector on the basis of the received beams.

In a further step, the reflectivity distribution is compared to a reference distribution, a fogged glass cover being ascertained in the event of a deviation of the reflectivity distribution from the reference distribution.

In an analogous manner to the ascertainment of a reflection pattern, it is possible to use the reflectivity distribution of the detector image to determine whether the glass cover of the LIDAR device is covered by vapor or ice.

For this purpose, the spatially resolved reflectivity may be evaluated in order to assess the fogging state of the glass cover. In particular, it is possible to use a comparison of the reflectivity of the reflection structure in the reflectivity of the glass cover in order to determine a fogging state.

According to one exemplary embodiment of the present invention, a heating structure of the glass cover is activated and/or controlled as a function of a degree of deviation of the reflectivity distribution from the reference distribution. By this measure, it is possible to control heating structures on the glass cover based on the monitoring of the fogging state of the glass cover. In particular, it is possible to regulate the electric power of the heating structure as a function of the fogging state. In case of a low degree of fogging, the heating structures may be operated with reduced electric power. This makes it possible to achieve an increased energy efficiency of the heating structure.

According to another aspect of the present invention, a LIDAR device for scanning a scanning range is provided. The LIDAR device has at least one beam source for generating beams and for emitting the beams into the scanning range. The LIDAR device furthermore has at least one detector for receiving beams reflected and/or backscattered from the scanning range, the beam source and the detector being situated so as to be protected by a glass cover. Furthermore, a control unit is provided for controlling the beam source and for evaluating the detector, the LIDAR device being designed to carry out at least one of the methods of the present invention.

The LIDAR device may be designed to carry out the method for the calibration and/or the method for ascertaining a fogged glass cover. On the basis of the received measurement data of the detector, the control unit is able to perform the evaluation of the respective reflectivity distribution or of the respective reflection pattern.

The LIDAR device may be developed as a rotating system, scanning system or as a flash system. The method makes it possible to calibrate the LIDAR device in a cost-efficient and technically simple manner.

According to one exemplary embodiment of the present invention, the reflection structure is situated on an inner surface of the glass cover or between a first glass cover layer and a second glass cover layer. So as to be protected against external influences, the reflection structure and/or the heating structure may be situated on the inner side of the glass cover or between two glass cover layers in the form of a coating or in an adhesively affixed form. This also makes it possible to exclude external influences on the online calibration.

According to another specific embodiment of the present invention, the reflection structure is situated in a scanning range of the LIDAR device or outside of the scanning range of the LIDAR device. Since the utilized visual range is often smaller than the actually measurable visual range or the scanning range of the LIDAR device, the surplus areas may be used to accommodate a reflection structure. This reflection structure may be developed for example in the form of supply lines for a homogeneous, transparent heating layer.

Furthermore, such an arrangement of the reflection structure outside of the scanning range offers a greater freedom of design with regard to the size, shape and reflectivity, so that the online calibration may be additionally optimized and that it does not impair the operation of the LIDAR device.

According to a further exemplary embodiment of the present invention, the reflection structure is designed as a heating structure, the reflection structure in the form of a heating structure comprising multiple electric heating lines and/or supply lines to the heating lines. The respective heating lines and/or supply lines may be used as the reflection structure in order to perform a calibration of the LIDAR device while in operation. This measure eliminates the need for additional modifications for calibrating the LIDAR device.

According to a further specific embodiment of the present invention, the electric heating lines and/or supply lines to the heating lines run diagonally, in the vertical direction and/or in the horizontal direction along the glass cover. The heating structures may be positioned in the entire visual range and may run horizontally and/or vertically. The heating lines and/or the supply lines may form a grid, for example. This makes it possible to detect a distortion both in the horizontal as well as in the vertical direction. A combined arrangement additionally increases the homogeneity of the temperature distribution on the glass cover, allowing the latter to be defrosted more efficiently.

In the following, preferred exemplary embodiments of the present invention are explained in more detail with reference to highly simplified schematic illustrations.

### BRIEF DESCRIPTION OF THE DRAWINGS

FIG. 1 shows a schematic representation of a LIDAR device according to one specific embodiment of the present invention.

FIG. 2 shows a schematic representation of a LIDAR device according to a further specific embodiment of the present invention.

FIG. 3 shows a schematic ghosted view through a glass cover having electric lines running in the horizontal direction, in accordance with an example embodiment of the present invention.

FIG. 4 shows a schematic ghosted view through a glass cover having electric lines running in the vertical direction, in accordance with an example embodiment of the present invention.

FIG. 5 shows a schematic ghosted view through a glass cover having electric lines running in the horizontal direction and in the vertical direction, in accordance with an example embodiment of the present invention.

FIG. 6 shows a schematic ghosted view through a glass cover having a reflection structure outside of a scanning range, in accordance with an example embodiment of the present invention.

FIGS. 7-9 show a schematic reflectivity distribution for illustrating a method for ascertaining a fogged glass cover, in accordance with an example embodiment of the present invention.

### DETAILED DESCRIPTION OF EXAMPLE EMBODIMENTS

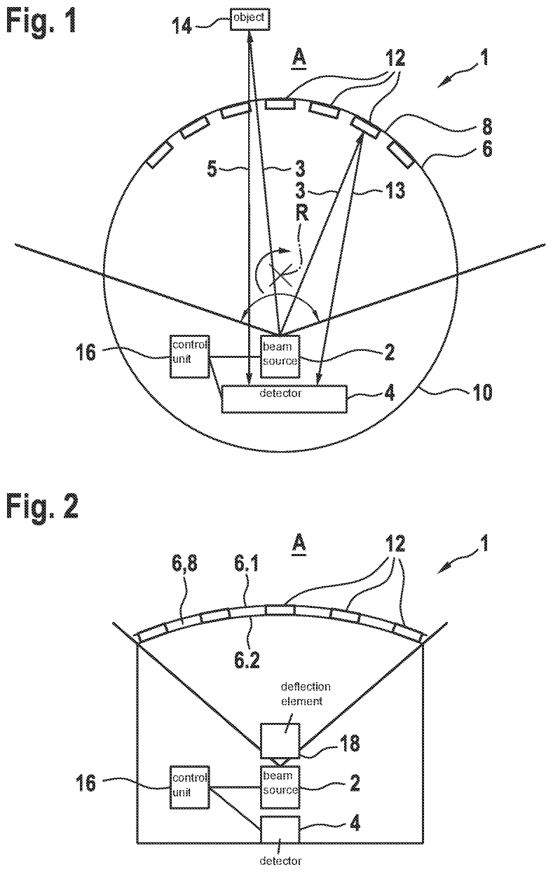

FIG. 1 shows a schematic illustration of a LIDAR device 1 according to one specific embodiment. LIDAR device 1 is used to scan a scanning range A and is developed for example as a rotating LIDAR device 1. In this instance, a beam source 2 and a detector 4 of LIDAR device 1 may be rotated or swiveled about an axis of rotation R.

Detector 4 and beam source 2 are situated in LIDAR device 1 protected by a glass cover 6. In the illustrated exemplary embodiment, glass cover 6 is designed to be tubular or circular and surrounds detector 4 and beam source 2. Detector 4 may be situated for example along an axis of rotation R displaced in height relative to beam source 2.

Not the entire glass cover 6 is utilized for scanning scanning range A. One utilized section 8 of glass cover 6 is used for emitting generated beams 3 into scanning range A.

In the illustrated exemplary embodiment, the section 8 utilized for scanning scanning range A corresponds to approx. half of class cover 6. Glass cover 6 furthermore has a section 10 that is not utilized for scanning scanning range A.

A reflection structure 12 is situated on glass cover 6. Reflection structure 12 may be situated for example on an inner side 7 of glass cover 6 or, as illustrated in FIG. 2, between two glass cover layers 6.1, 6.2. Reflection structure 12 may be used exclusively for reflecting generated beams 3 or may have an additional heating function.

Scanning range A is scanned by generated beams 3, so that objects 14 located in scanning range A may be detected. In the process, generated beams 3 are reflected or backscattered by object 14. Beams 5 reflected and/or backscattered by object 14 are received by detector 4. Generated beams 3 are furthermore also reflected and/or backscattered by reflection structure 12.

Beams 13 reflected and/or backscattered by reflection structure 12 are likewise received by detector 4.

LIDAR device 1 has a control unit 16, which is designed to control beam source 2 and to receive and evaluate measurement data of detector 4. Control unit 16 may moreover be used for controlling and regulating the reflection structure 12 in the form of a heating structure.

By evaluating the reflected and/or backscattered beams 5, 13, control unit 16 is able to ascertain the position of reflection structure 12 and use it to perform an online calibration.

FIG. 2 shows a schematic illustration of a LIDAR device 1 according to a further specific embodiment. In contrast to the exemplary embodiment shown in FIG. 1, the LIDAR device has a glass cover 6, which is essentially made up of a section 8 used for scanning scanning range A. Glass cover 6 is developed as a section or segment of a glass cover covering a 360° angle.

Glass cover 6 is made up of a first glass cover layer 6.1 and a second glass cover layer 6.2. Reflection structure 12 is situated between the two glass cover layers 6.1, 6.2.

LIDAR device 1 may be developed as a scanning system, in which for example a deflection element 18 deflects the generated beams 3 along scanning range A. Deflection element 18 may be a mirror or a prism, for example.

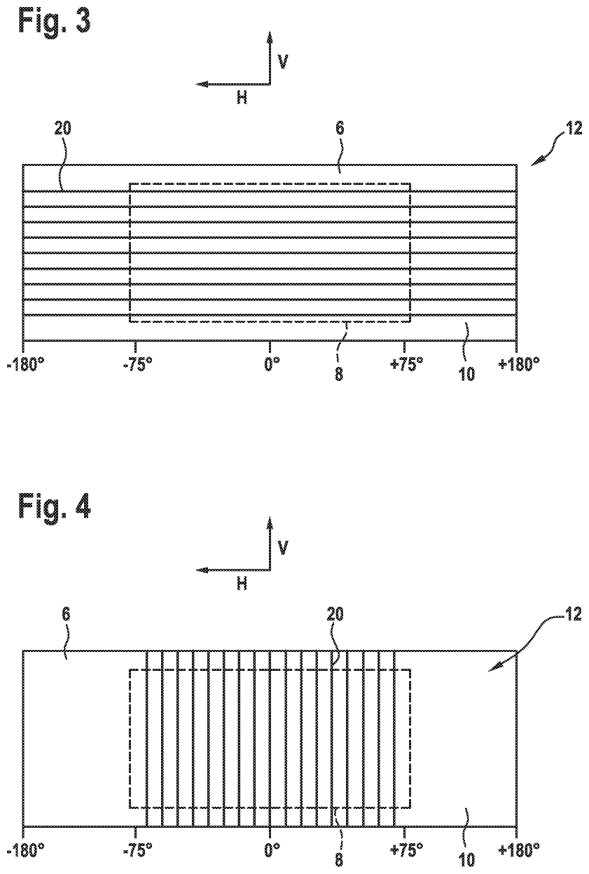

FIG. 3 shows a schematic ghosted view through a glass cover 6 having electric lines 20 running in the horizontal direction H. Electric lines 20 form a reflection structure 12 in the form of a heating structure and may be ascertained by detector 4 in order to be used for an online calibration or a detection of a fogged glass cover 6.

FIG. 3 shows section 8 used for scanning scanning range A and section 10, which is not used for scanning scanning range A. Electric lines 20 extend through both sections 8, 10.

FIG. 4 shows a schematic ghosted view through a glass cover 6 having electric lines 20 running in the vertical direction V, which take the form of a heating structure.

Electric lines 20 may be connected directly or indirectly to control unit 16. Control unit 16 is able to set an electric current, which is conducted through electric lines 20, in order to prevent glass cover 6 from fogging or frosting.

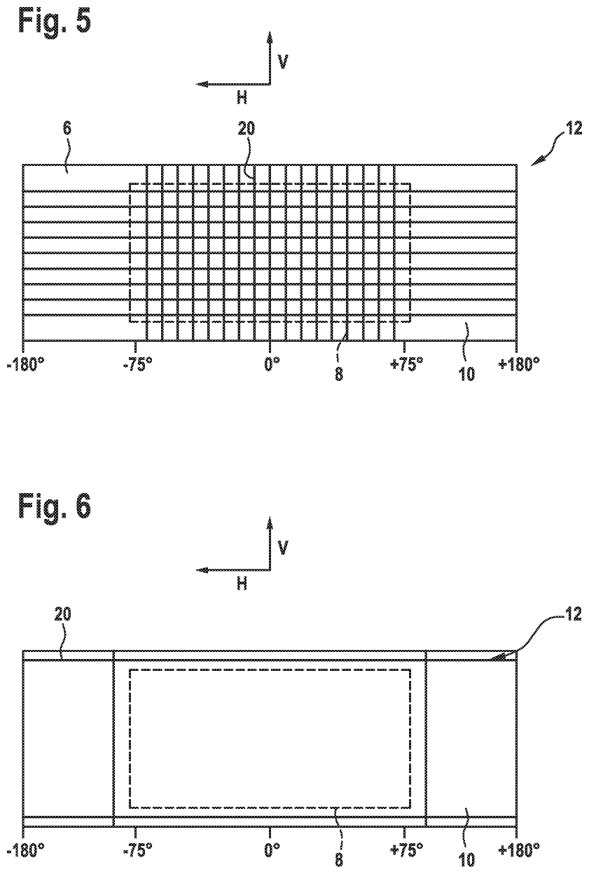

FIG. 5 shows a schematic ghosted view through a glass cover 6 having electric lines 20 running in the horizontal direction H and in the vertical direction V. This makes it possible to achieve a combination of glass covers 6 shown in FIG. 3 and FIG. 4, which allows for a homogeneous heat distribution on section 8 used for scanning scanning range A.

FIG. 6 shows a schematic ghosted view through a glass cover 6 having a reflection structure 12 outside of a section 8 used for scanning scanning range A. This makes it possible for the section 8 of glass cover 6 used for scanning scanning range A to remain free of reflection structure 12. In order to perform an online calibration, reflection structure 12 may be ascertained for example by briefly swiveling beam source 2 and detector 4 beyond section 8.

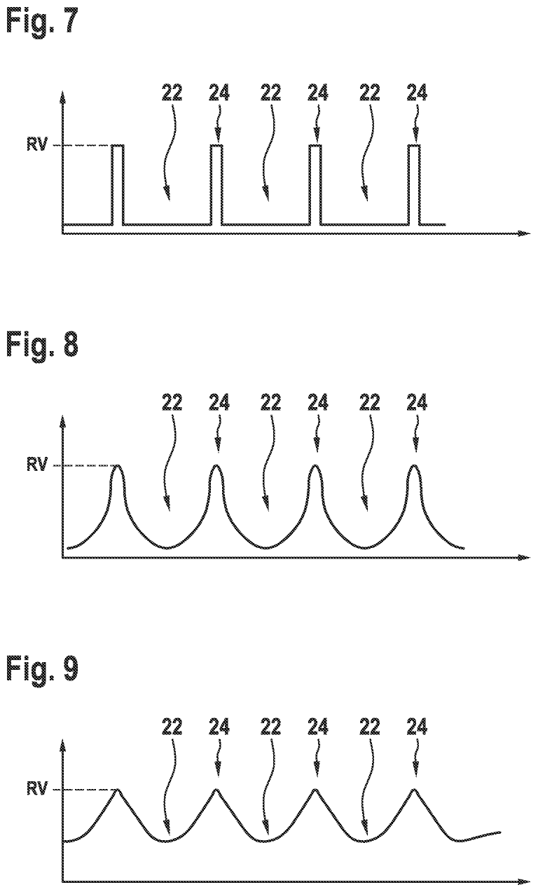

FIG. 7, FIG. 8 and FIG. 9 show schematic reflectivity distribution RV to illustrate a method for ascertaining a fogged glass cover 6. Reflectivity distribution RV in this instance includes reflectivities 22 of object 14 in scanning range A and reflectivities 24 of reflection structure 12.

Reflectivity 22 of object 14 is ascertained on the basis of beams 5 reflected and/or backscattered by object 14. Reflectivity 24 of reflection structure 12 is ascertained by receiving and evaluating the beams 13 reflected and/or backscattered by reflection structure 12.

FIG. 7 shows a reference distribution of the reflectivity, which corresponds to a reflectivity distribution RV of a glass cover that is not fogged. FIG. 8 shows a reflectivity distribution RV of a lightly or slightly fogged glass cover 6. FIG. 9 shows a reflectivity distribution RV of a heavily fogged glass cover 6.

It is clear that with the increasing degree of fogging of glass cover 6, a contrast between reflectivity 22 of object 14 in scanning range A and reflectivity 24 of reflection structure 12 decreases and that a transition between the two reflectivities 22, 24 becomes blurred.

What is claimed is:

1. A method for calibrating a LIDAR device, comprising the following steps:
generating and emitting beams by a beam source;
receiving, by a detector, beams reflected and/or backscattered by objects in a scanning range of the LIDAR device, and beams reflected and/or backscattered by a reflection structure applied on a glass cover of the LIDAR device;
ascertaining a reflection pattern based on the beams reflected and/or backscattered by the reflection structure applied on the glass cover, and comparing the ascertained reflection pattern to a reference pattern; and
based on a deviation between the ascertained reflection pattern and the reference pattern, taking at least one corrective measure for calibrating the LIDAR device.

2. The method as recited in claim 1, wherein the reflection pattern is ascertained from beams reflected and/or backscattered by a reflection structure in the form of a heating structure.

3. A method for ascertaining a fogged glass cover of a LIDAR device, comprising the following steps:
generating and emitting beams by a beam source of the LIDAR device;
receiving, by a detector, beams reflected and/or backscattered by objects in a scanning range of the LIDAR device and beams reflected and/or backscattered by a reflection structure applied on a glass cover of the LIDAR device;
ascertaining, based on the received beams, a reflectivity distribution of the reflection structure and of at least one reflectivity of the objects in the scanning range;
comparing the reflectivity distribution to a reference distribution; and
ascertaining a fogged glass cover based on a deviation of the reflectivity distribution from the reference distribution.

4. The method as recited in claim 3, wherein a heating structure of the glass cover is activated and/or controlled as a function of a degree of deviation of the reflectivity distribution from the reference distribution.

5. A LIDAR device for scanning a scanning range, comprising:
at least one beam source configured to generate beams and to emit the beams into the scanning range;
at least one detector configured to receive beams reflected and/or backscattered from the scanning range, the beam source and the detector being situated so as to be protected by a glass cover;
a control unit configured to control the beam source and to evaluate the detector;
wherein the LIDAR device is configured to:
generate and emit beams by a beam source;
receive, by a detector, beams reflected and/or backscattered by objects in a scanning range of the LIDAR device, and beams reflected and/or backscattered by a reflection structure applied on a glass cover of the LIDAR device;
ascertain a reflection pattern based on the beams reflected and/or backscattered by the reflection structure applied on the glass cover, and comparing the ascertained reflection pattern to a reference pattern; and
based on a deviation between the ascertained reflection pattern and the reference pattern, take at least one corrective measure for calibrating the LIDAR device.

6. The LIDAR device as recited in claim 5, wherein the reflection structure is situated on an inner surface of the glass cover or between a first glass cover layer and a second glass cover layer.

7. The LIDAR device as recited in claim 5, wherein the reflection structure is situated in a section of the glass cover of the LIDAR device used for scanning the scanning range or outside of the section of the glass cover of the LIDAR device used for scanning the scanning range.

8. The LIDAR device as recited in claim 5, wherein the reflection structure is in the form of a heating structure, the reflection structure in the form of a heating structure including multiple electric heating lines and/or supply lines to the heating lines.

9. The LIDAR device as recited in claim 8, wherein the electric heating lines and/or supply lines to the heating lines run in a vertical direction, and/or in a horizontal direction and/or diagonally along the glass cover.

10. A LIDAR device for scanning a scanning range, comprising:
at least one beam source configured to generate beams and to emit the beams into the scanning range;
at least one detector configured to receive beams reflected and/or backscattered from the scanning range, the beam source and the detector being situated so as to be protected by a glass cover;
a control unit configured to control the beam source and to evaluate the detector;
wherein the LIDAR device is configured to:
generate and emit beams using the beam source;
receive, using the detector, beams reflected and/or backscattered by objects in a scanning range of the LIDAR device and beams reflected and/or backscattered by a reflection structure applied on the glass cover of the LIDAR device;
ascertain, based on the received beams, a reflectivity distribution of the reflection structure and of at least one reflectivity of the objects in the scanning range;
compare the reflectivity distribution to a reference distribution; and
ascertain a fogged glass cover based on a deviation of the reflectivity distribution from the reference distribution.
